(19) United States
(12) Patent Application Publication
(10) Pub. No.: US 2017/0243121 A1
(43) Pub. Date: Aug. 24, 2017

(54) TRAFFIC FORECASTING SYSTEM, TRAFFIC FORECASTING METHOD AND TRAFFIC MODEL ESTABLISHING METHOD

(71) Applicant: INSTITUTE FOR INFORMATION INDUSTRY, TAIPEI (TW)

(72) Inventor: Ching-Hao Lai, TAICHUNG CITY (TW)

(21) Appl. No.: 15/077,989

(22) Filed: Mar. 23, 2016

(30) Foreign Application Priority Data
Feb. 22, 2016 (TW) 105105145

(51) Int. Cl. G06N 5/04; G06F 17/11; G06N 99/00

(52) U.S. Cl. CPC G06N 5/04; G06N 99/005; G06F 17/11

(57) ABSTRACT

A traffic forecasting system configured to forecast a travel time of a route is disclosed. The traffic forecasting system includes a model-training module, a model-selecting module and a forecasting module. The model-training module builds multiple candidate models. Each of the candidate models corresponds to one of a plurality of road section and one of a plurality of mathematical models. The model-selecting module selects an estimated model corresponding to the road section from the candidate models matching the road sections of the route. The forecasting module calculates estimated vehicle speeds of each road section according to the estimated models of each road section of the route. The model-selecting module selects one of the candidate models corresponding to the road section with the smallest error as the estimated model of the road section.

### RELATED APPLICATIONS

This application claims priority to Taiwan Application Serial Number 105105145, filed Feb. 22, 2016, which is herein incorporated by reference.

### BACKGROUND

Technical Field

The present disclosure relates to traffic forecasting system and method, and in particular, to traffic forecasting system and method with mixing models.

Description of Related Art

The navigation systems in the market and online map nowadays is configured to use a single algorithm model to forecast the traffic speed when performing the travel time estimation, and is unable to adjust or varies the algorithm models based on different time sections and road sections, so there is a significant error between the estimated travel time and the actual travel time.

In addition, the models nowadays is unable to tune and adjust the algorithm and the estimated travel time base on different situations, so the travel time cannot be estimated accurately when facing special situations such as activities, accidents, or bad weather circumstance.

### SUMMARY

To solve the problem stated above, one aspect of the present disclosure is a traffic forecasting system. The traffic forecasting system is configured to forecast a traffic time of a route. The traffic forecasting system includes a model-training module, a model-selecting module and a forecasting module. The model-training module builds multiple candidate models. Each of the candidate models corresponds to one of a plurality of road section and one of a plurality of mathematical models. The model-selecting module selects an estimated model corresponding to the road section from the candidate models matching the road sections of the route. The forecasting module calculates estimated vehicle speeds of each road section according to the estimated models of each road section of the route. The model-selecting module selects one of the candidate models corresponding to the road section with the smallest error as the estimated model of the road section.

Another aspect of the present disclosure is a traffic forecasting method performed by a processor. The traffic forecasting method includes following steps: (a) receiving, by the processor, at least one real-time data; (b) selecting, by the processor, one of a plurality of candidate models corresponding to a route for each road sections of the route as the estimated model of the road section; (c) calculating, by the processor, a traffic time according to the corresponding estimated model of the road sections of the route. The estimated model of each road section are selected according to the real-time data and a historical data in a database such that the candidate model corresponding to the road section with the smallest error is selected as the estimated model of the road section.

Another aspect of the present disclosure is a traffic model establishing method performed by a processor. The traffic model establishing method includes following steps: (a) receiving, by the processor, at least one real-time data wherein the at least one real-time data includes a speed information; (b) mapping, by the processor, the speed information in the at least one real-time data to corresponding one of a plurality of road sections in a map data; and (c) calculating, by the processor, a plurality of candidate models corresponding to a plurality of different mathematical models for each of the road sections, such that a model-selecting module selects one of the candidate models of the road sections as an estimated model of the corresponding road section according to the at least one real-time data and a historical data in a traffic historical database.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a diagram illustrating a traffic forecasting system according to some embodiments of the present disclosure.

FIG. 2A and FIG. 2B are diagrams illustrating the data-recovering module according to some embodiments of the present disclosure.

FIG. 3 is a diagram illustrating the operation of the model-training module according to some embodiment of the present disclosure.

FIG. 4 is a diagram illustrating the operation of the model-selecting module according to some embodiments of the present disclosure.

FIG. 5 is a diagram illustrating the situation information analyzing unit according to some embodiments of the present disclosure.

FIG. 6 is a flowchart illustrating a traffic forecasting method according to some embodiments of the present disclosure.

FIG. 7 is a flowchart illustrating a traffic model establishing method according to some embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

The terms “about” and “approximately” in the disclosure are used as equivalents. Any numerals used in this disclosure with or without “about,” “approximately,” etc. are meant to cover any normal fluctuations appreciated by one of ordinary skill in the relevant art. In certain embodiments, the term “approximately” or “about” refers to a range of values that fall within 20%, 10%, 5%, or less in either direction (greater or less than) of the stated reference value unless otherwise stated or otherwise evident from the context.

In the following description and in the claims, the terms “include” and “comprise” are used in an open-ended fashion, and thus should be interpreted to mean “include, but not limited to.” As used herein, the term “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

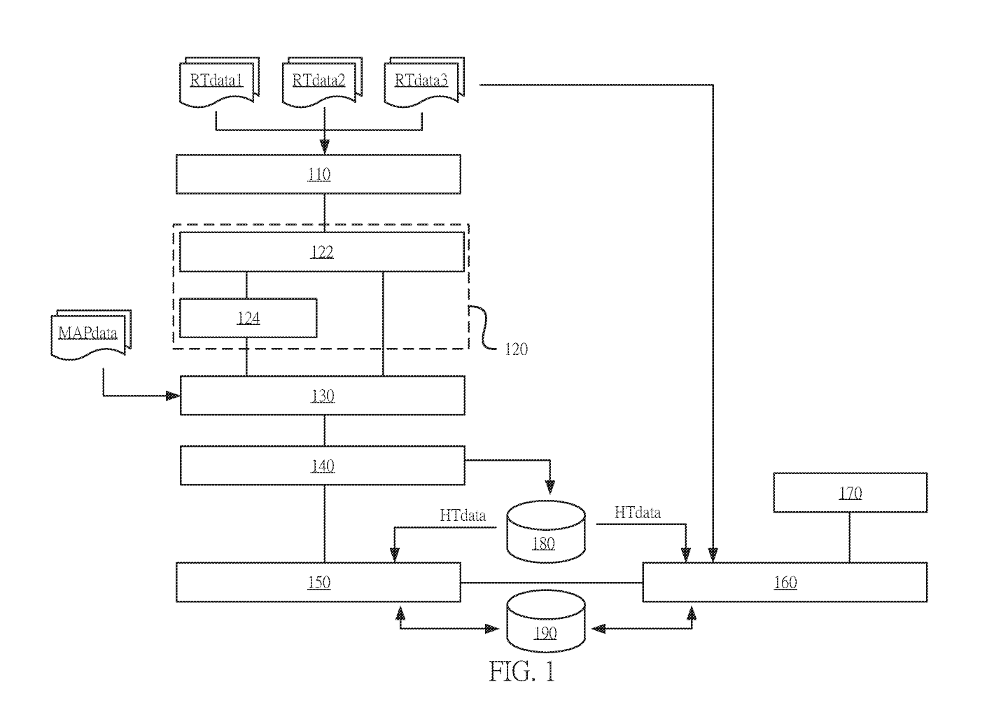

Reference is made to FIG. 1. FIG. 1 is a diagram illustrating a traffic forecasting system 100 according to some embodiments of the present disclosure. The traffic forecasting system 100 may calculate according to the route chosen by the user to forecast the traffic time required for the route. As illustratively shown in FIG. 1, the traffic forecasting system 100 includes a data-receiving module 110, a data-processing module 120, a road section mapping module 130, a data recovery module 140, a model-training module 150, a model-selecting module 160, a forecasting module 170, a traffic historical database 180 and a model database 190. The function and the interaction operation of each module in the traffic forecasting system 100 will be explained in details in the following paragraphs.

The data receiving module 110 is configured to receive real-time data RTdata1˜RTdata3. In some embodiments, the real-time data RTdata1 may include the real-time speed record information corresponding to different road sections. For example, in some embodiments, the real-time data RTdata1 may be the vehicle speed information received by a Vehicle Detector (VD), or the vehicle speed information received by GPS-Based Vehicle Probe (GVP), but the present disclosure is not limited thereto. In some other embodiments, the data receiving module 110 may also receive the real-time data RTdata1 by using ETC-Based Vehicle Probe (EVP) or Cellular-Based Vehicle Probe (CVP) to obtain the current traffic speed and traffic status of different road sections or different directions of the road sections.

In addition, in some embodiments, the data-receiving module 110 may further receive various types of real-time data. For example, the real-time data RTdata2 may include traffic event information in different categories, such as the vehicle accidents occurred at the road section or blow-out tire, obstacles like falling rocks and landslides at the road section, or a traffic jam at the road sections. Furthermore, the real-time data RTdata2 may also include various activities information. For example, large-scaled activities such as a ball game or a concert are held. Specifically, the data-receiving module 110 may obtain event information and activities information from various databases (e.g., traffic database of National Freeway Bureau, etc.) as the real-time data RTdata2.

Similarly, in some embodiments, data-receiving module 110 may also receive weather information as the real-data RTdata3. For example, the real-time data RTdata3 may include storm, snow, fog information which have impact to the traffic speed. It is noted that the above-mentioned event information, activities information and weather information may be considered as situation information. Different situations (i.e., accidents, activities, and weather) impact the traffic status and traffic speed correspondingly. Thus, traffic forecasting system 100 may forecast the travel time more accurately by analyzing whether a situation occurs and the type of the situation.

The data-processing module 120 is coupled to the data-receiving module 110 and configured to perform data processing to the real-time data RTdata1˜RTdata3 received by the data-receiving module 110 for the later operation of the traffic forecasting system 100. Specifically, in some embodiments, the data-processing module 120 includes a data normalization unit 122 and a situation information analyzing unit 124. Since the real-time data RTdata1˜RTdata3 may include different data sources and data types, the data normalization unit 122 may normalize the real-time data RTdata1˜RTdata3 such that the traffic forecasting system 100 may use the speed information from different sources (e.g., VD, GVP, CVP, etc.) and situation information with different types and categories.

The road section mapping module 130 may map the processed speed information to corresponding road section in a map data MAPdata. For example, for the speed information received from VD may be mapped to the corresponding road sections where the detector located and to the adjacent road sections. For the information received from vehicle probes may be mapped to the corresponding road sections where the vehicle probes pass through at the time and to the adjacent road sections.

In some embodiments, the road section mapping module 130 may divide the road in the map data MAPdata into different road sections via road segment clustering. For one skilled in the art, road segment clustering may be realized in various ways and thus are omitted for the sake of the brevity.

Accordingly, the traffic forecasting system 100 may map the speed information in the real-time data RTdata1 to the corresponding time period and the corresponding road section, and store the real-time data RTdata1 as the historical data HTdata in the traffic historical database 180.

As illustratively shown in FIG. 1, in some embodiments, the data-recovery module 140 in the traffic forecasting system 100 is coupled to the traffic historical database 180 and configured to calculate the speed of the time period missing the speed record in the road section according to the historical data HTdata so as to recover the historical data HTdata.

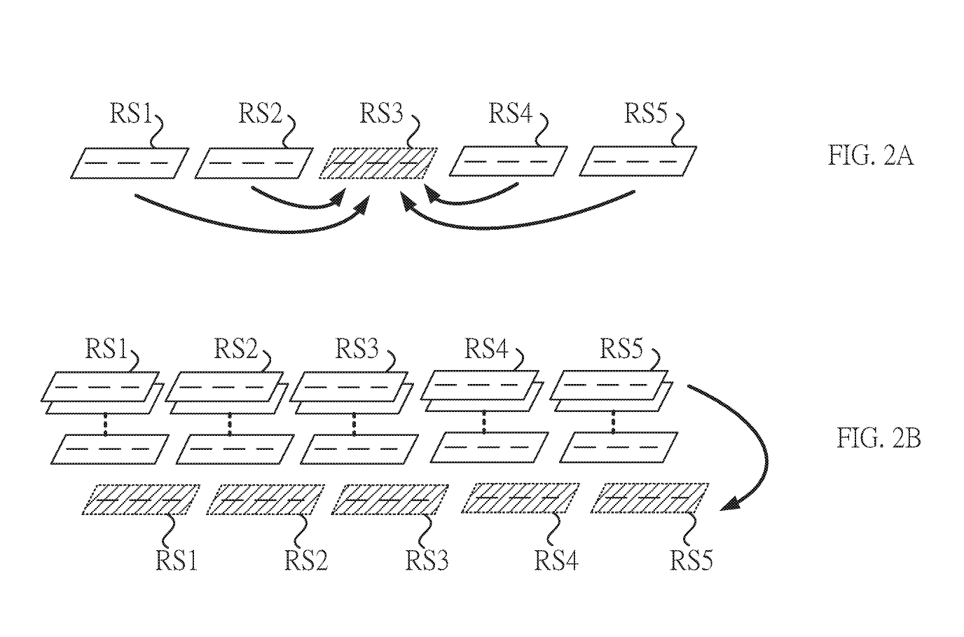

References are made to FIG. 2A and FIG. 2B. FIG. 2A and FIG. 2B are diagrams illustrating the data-recovering module 140 according to some embodiments of the present disclosure. Specifically, there may be two ways for the data-recovery module 140 to recover the data, including time-series data recovery and space-series data recovery. As illustratively shown in FIG. 2A, in the road sections RS1˜RS5, when the speed information of the road section RS1˜RS2 and RS4˜RS5 are known, the speed information of the road section RS3 remains unknown, the data-recovery module 140 may use the space-series data recovery and perform calculation according to the known speed information of adjacent road sections RS1˜RS2 and RS4˜RS5 to obtain the speed information of the road section RS3. In various embodiments, data-recovery module 140 may use different statistic methods to calculate the speed information of the road section RS3. For example, in some embodiments, data-recovery module 140 may use Maximum Likelihood (ML) method to calculate the speed information of the road section RS3. It is noted that in other embodiments, the data-recovery module 140 may use arithmetical average, weighted average, or other method to calculate the speed information of the road section RS3, so the present disclosure is not limited thereto.

As illustratively shown in FIG. 2B, when the speed information of the adjacent road sections RS1˜RS5 are unknown and the space-series recovery is not applicable, the data-recovery module 140 may use time-series recovery and calculate according to the historical data at adjacent time periods to obtain the speed information of the road section RS1˜RS5. For example, the data-recovery module 140 may use the speed information of the previous time period as the speed information of the next time period, or perform calculation using the speed information of multiple time periods in the past according to aforementioned statistic methods such as maximum likelihood, arithmetical average, weighted average, etc. to obtain the speed information of the road section RS1˜RS5. Thus, the traffic forecasting system 100 in the present disclosure may recover the data by the data-recovery module 140 and ensure the completeness of the historical data HTdata in the traffic historical database 180.

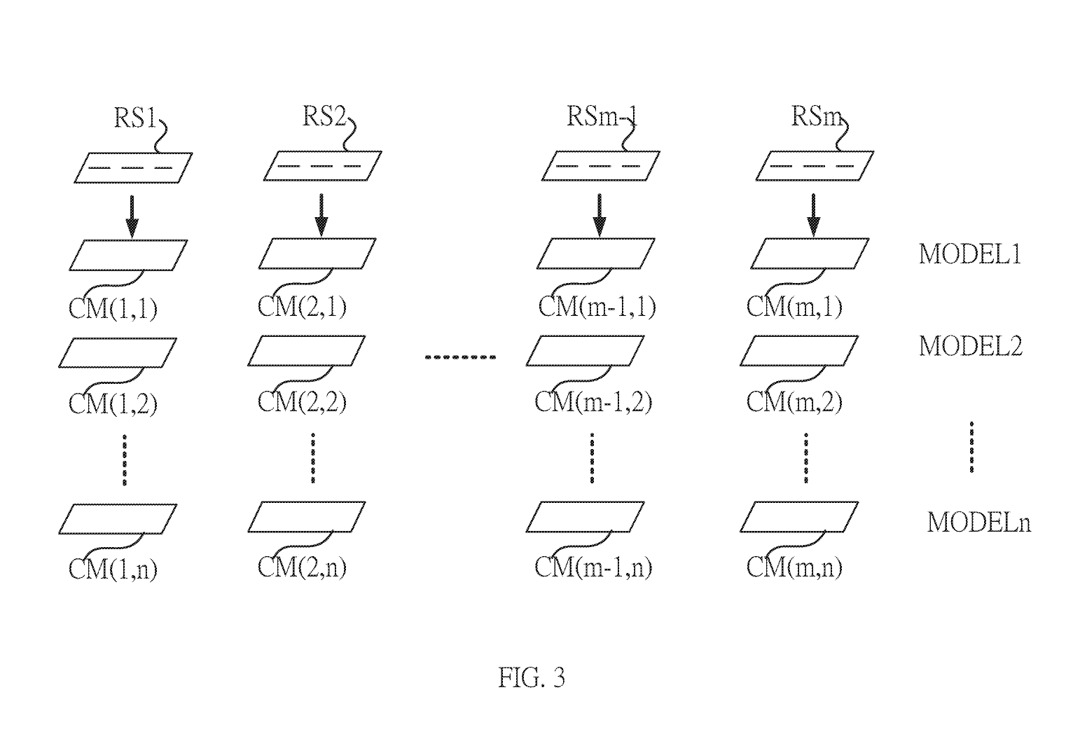

The model-training module 150 is configured to build a plurality of candidate models CM(1,1)˜CM(m,n). Reference is made to FIG. 3. FIG. 3 is a diagram illustrating the operation of the model-training module 150 according to some embodiment of the present disclosure. For example, the candidate models CM(1,1)˜CM(1,n) correspond to the road section RS1, and correspond to a plurality of different mathematical models MODEL1˜MODELn respectively. The candidate models CM(2,1)˜CM(2,n) correspond to the road section RS2, and correspond to the mathematical models MODEL1˜MODELn respectively, and so on. Alternatively stated, the candidate model CM(x,y) includes the estimated vehicle speed value of the road section RSx corresponds to the mathematical model MODELy, in which x is any integer between 1 and m, and y is any integer between 1 and n. In some embodiments, for any candidate model (e.g., candidate model CM(x,y)), the mathematical models MODEL1˜MODELn generates the candidate models CM(1,1)˜CM(1,n) of the corresponding road section (e.g., road section RS1), in which the candidate models CM(1,1)˜CM(1,n) are calculated with different time periods, different statistical algorithms, different situations, and/or different future time for estimation.

For example, in some embodiments, the mathematical models MODEL1 may apply radial basis function (RBF) kernel to execute Support Vector Regression (SVR) to calculate the candidate models CM(1,1)˜CM(m,1) of different road sections RS1˜RSm respectively. Other mathematical model MODEL2 may use other function kernel known by one skilled in the art to calculate the candidate models CM(1,2)˜CM(m,2) of different road sections RS1˜RSm respectively. For example, MODEL2 may apply Polynomial kernel, linear kernel, Hyperbolic tangent kernel, Laplacian Kernel, etc., but the present disclosure is not limited thereto.

In addition, the mathematical model MODEL3 may use the aforementioned function kernel to execute Gaussian Process Regression to calculate the candidate models CM(1,3)˜CM(m,3) of different road sections RS1˜RSm respectively. The mathematical model MODEL4 may use the aforementioned function kernel to execute Relevance Vector Machine Regression (RVM) to calculate the candidate models CM(1,4)˜CM(m,4) of different road sections RS1˜RSm respectively, and so on.

Alternatively stated, the mathematical models MODEL1˜MODELn may indicate the models of various regression methods pairing various function kernels. Thus, the model-training module 150 may build the candidate models CM(1,1)˜CM(m,n) corresponds to the road sections RD1˜RDm and one of the mathematical models MODEL1˜MODELn respectively according to the historical data HTdata in the traffic historical database 180 and the data provided by the data-recovery module 140. In some embodiments, the model-training module may perform iterative computations and calculate the candidate models CM(1,1)˜CM(m, n) of the mathematical models MODEL1˜MODELn according to the following equation:

$${ɛ}_{i , j , l , d , t , k} = \frac{1}{M} {\sum }_{m = 0}^{M} \vert \frac{\hat{x} ( m ) - x ( m )}{x ( m )} \vert \times 100 \%$$

$${Ψ}_{j , l , d , t , k} = arg {min}_{i} \{ {ɛ}_{i , j , l , d , t , k} \}$$

In which i indicates the number of iteration, j indicates the road section, l indicates the time period, d indicates, t indicates the future time for estimation, k indicates the mathematical models. \hat{x}(m) and x(m) indicates the estimated value and the actual value respectively. ε_{i,j,l,d,t,k} indicates the error value of the time period l of the road section j of the direction d to the future time t using the mathematical model k under the i-th iteration. Ψ_{j,l,d,t,k} indicates the estimated value of the time period l of the road section j of the direction d to the future time t using the mathematical model k.

Alternatively stated, in some embodiments, the model-training module 150 is configured to build a plurality of candidate models based on different mathematical models and different situations such as events, activities, rainfall, etc. for each road section using the corresponding historical data which may be used in the forecasting. The candidate model CM(1,1)˜CM(m, n) may be stored in the model database 190 after training and building, and to be used by the model-selecting module 160.

The model-selecting module 160 is coupled to the model-training module 150 and configured to analyze the route chosen by the user so as to obtain the road sections included in the route, and select the estimated model corresponding to the road section from the candidate models CM(1,1)˜CM(m, n) matching the road sections in the route respectively. Alternatively stated, the model-selecting module 160 is configured to select the proper candidate models CM(1,1)˜CM(m, n) with the smallest error using the difference between the estimated and the actual speed, and with the different situations. The selected models are then used by the forecasting module 170 in order to forecast the traffic speed.

The model database 190 is coupled to the model-training module 150 and the module-selecting module 160 and configured to store the candidate models CM(1,1)˜CM(m, n) corresponding to each road section RS1˜RSm with different time periods, different situations and different mathematical models.

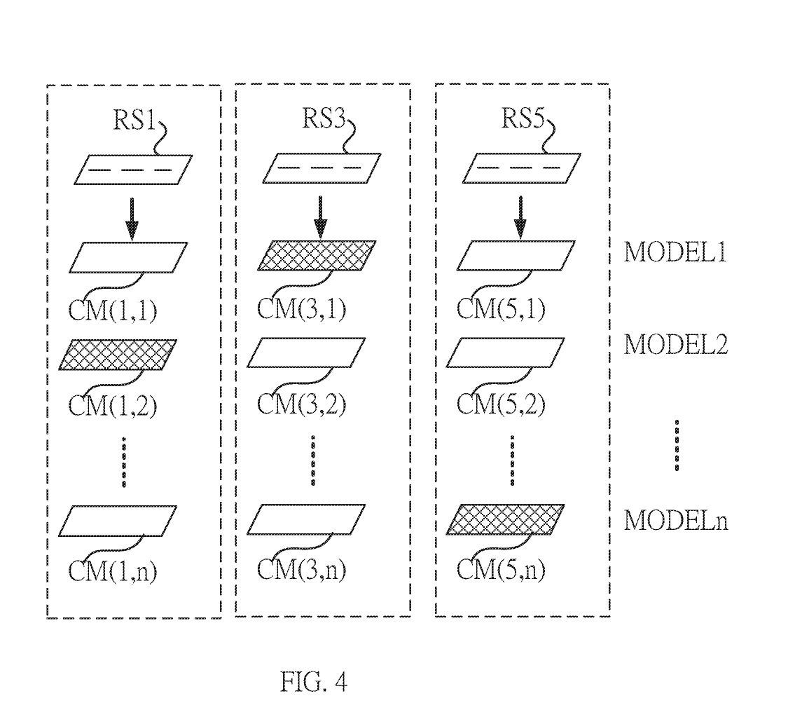

Reference is made in accompany with FIG. 4. FIG. 4 is a diagram illustrating the operation of the model-selecting module 160 according to some embodiments of the present disclosure. For example, in some embodiments, assuming the model-selecting module 160 determines the route includes road section RS1, RS3, and RS5, then the model-selecting module 160 may respectively select the estimated modules corresponding to road section RS1, RS3, and RS5 from the candidate models CM(1,1)˜CM(1, n), CM(3,1)˜CM(3, n), and CM(5,1)˜CM(5, n) corresponding to road section RS1, RS3, and RS5. Specifically, the model-selecting module 160 may select one of the candidate models CM(1,1)˜CM(1, n) corresponding to the road section R1 as the estimated model of the road section RS1 (e.g., the candidate model CM(1, 2) in FIG. 4), and select one of the candidate models CM(3, 1)˜CM(3, n) corresponding to the road section R3 as the estimated model of the road section RS3 (e.g., the candidate model CM(3, 1) in FIG. 4), and select one of the candidate models CM(5, 1)˜CM(5, n) corresponding to the road section R5 as the estimated model of the road section RS5 (e.g., the candidate model CM(5, n) in FIG. 4).

In some embodiments, the model-selecting module 160 may calculate and select the estimated model of each road section by using the following equation:

$${φ}_{j , l , d , t} = arg {min}_{k} \{ \vert {Target}_{j , l , d , t} - {Ψ}_{j , l , d , t , k} \vert \}$$

In which φ_{i,l,d,t} indicates the better model to be selected for the time period l of the road section j of the direction d to the future time t. Target_{j,l,d,t} indicates the actual value of the time period l of the road section j of the direction d to the future time t according to the historical data HTdata. Ψ_{j,l,d,t,k} indicates the estimated value of the time period l of the road section j of the direction d to the future time t using the mathematical model k. Alternatively stated, according to the above equation, the model-selecting module 160 is configured to select the estimated model with the smallest error and the highest accuracy (e.g., the candidate model CM(1, 2) corresponding to the road section R1, the candidate model CM(3, 1) corresponding to the road section R3, and the candidate model CM(5, n) corresponding to the road section R5) as the estimated model for the corresponding road section.

The model-selecting module 160 may transmit the outcome to the forecasting module 170. Accordingly, the forecasting module 170 may calculate the estimated vehicle speed for each road section according to the corresponding estimated model, and then calculate the estimated travel time of the route. For example, the forecasting module 170 may divide the distance of the road section RS1 by the corresponding estimated vehicle speed (i.e., the candidate model CM(1,2)) of the road section RS1 to find the travel time of the road section RS1, divide the distance of the road section RS3 by the corresponding estimated vehicle speed (i.e., the candidate model CM(3,1)) of the road section RS3 to find the travel time of the road section RS3, and divide the distance of the road section RS5 by the corresponding estimated vehicle speed (i.e., the candidate model CM(5,n)) of the road section RS5 to find the travel time of the road section RS5. In the end, the forecasting module 170 may sum up the travel time required for all the road sections RS1, RS3, and RS5 in the route so as to calculate the travel time of the route.

In some embodiments, the forecasting module 170 may also train and build forecasting models, or add the characteristic value (e.g., the known speed value of the road section or additional information such as weather and events) for forecasting with the models already trained and built to calculate the estimated vehicle speed. In some embodiments, the forecasting module builds models in batches periodically and choose the better one of the candidate models as the estimated models in each estimation, and import the real-time data RT1˜RT3 into the estimated models to obtain the estimated vehicle speed. It is noted that the estimated vehicle speed varies due to the change of the time and output different values. For example, the estimated vehicle speed of 12:00 for the next five minutes may be different from the estimated vehicle speed of 12:30 for the next five minutes, and the known data imported into the estimated model may be also different. For example, at 12:00, the speed information of 11:50˜12:00 may be imported to estimate the speed of the corresponding road section in a specific time period later than 12:00.

In some embodiments, the traffic forecasting system 100 further includes a model-rebuilding module. The model-rebuilding module may be used to adjust the parameters of the models already built according to the real-time data RTdata1˜RTdata3. Thus, the model-rebuilding module may be configured to keep the accuracy and adaptability of the newly introduced real-time data RTdata1˜RTdata3.

Alternatively stated, by the interactive operation of the data-receiving module 110, the data-processing module 120, the road section mapping module 130, the data-recovery module 140, the model-training module 150 and the database 180 in the traffic forecasting system 100, the model-training module 150 may generate multiple candidate models CM(1, 1)˜CM(m, n) for each road section RS1˜RSm.

Next, by the interactive operation of the model-training module 150, the model-selecting module 160, the forecasting module 170 and the database 180, the model-selecting module 160 may select the data with higher accuracy in the candidate models CM(1, 1)˜CM(m, n) of the road sections in the route as the estimated models to calculate the estimated vehicle speed such that the forecasting module 170 may perform an integrated computation to calculate the estimated vehicle speed of each road section in order to obtain the estimated travel time of the route. Thus, since the estimated model selected for each road section is the estimated model with high accuracy, the total accuracy can be enhanced efficiently. Specifically, the model-selecting module 160 selects the candidate model with the smallest error as the estimated model of the corresponding road section according to the difference of the estimated vehicle speed value and the actual speed value calculated by each candidate model CM(1, 1)˜CM(m, n).

It is noted that, as stated in the above paragraphs, in some embodiments, the data-receiving module 110 may also retrieve various types of situation information including event information, activities information and weather information from various databases as the real-time data RTdata2˜RTdata3.

Similar to the real-time data RTdata1, the real-time data RTdata2˜RTdata3 may be normalized by the data normalization unit 122. Next, the situation information analyzing unit 124 receives the normalized situation information and calculate the impact caused by the situation to the speed of different road sections at different time periods according to the situation information, to obtain the weight coefficient of the situation to the speed.

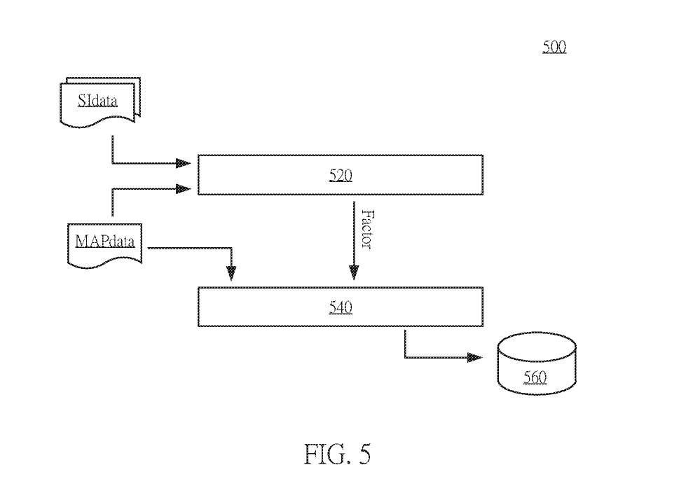

Reference is made to FIG. 5. FIG. 5 is a diagram illustrating the situation information analyzing unit 500 according to some embodiments of the present disclosure. As illustratively shown in FIG. 5, the situation information analyzing unit 500 includes a weight coefficient computing circuit 520 and a situation model forecasting circuit 540. The weight coefficient computing circuit 520 is configured to compute the weight coefficients of the event situation to different time periods and different road sections respectively according to the categories of the event situation, and the time and the location of which the event situation occurs (i.e., the situation information SIdata).

For example, in some embodiments, the weight coefficient of the situation information may be expressed by the following equation:

$${Factor}_{j , E} = {ω}_{d} \frac{\sum \vert {Speed}_{l , nonevent} - {Speed}_{l , event} \vert}{{D}_{E}} + {ω}_{t} \frac{\sum \vert {Speed}_{l , nonevent} - {Speed}_{l , event} \vert}{min ( Now \text{-} Starttime , Now \text{-} Endtime )}$$

In which Factor_{j,E} indicates the weight coefficient of situation E to the road section j. ω_{d} and ωₜ respectively indicate the weight of the distance to the situation and the weight of the time difference to the situation. Speed_{l,nonevent} indicates the speed without situation for time period l. Speed_{l,event} indicates the speed with situation for time period l. D_{E} indicates the distance to the situation. Now indicates the current time period, Starttime indicates the starting time of the situation, and Endtime indicates the ending time of the situation. As shown in the equation, as the larger distance between the road section j and the location of the situation E, or the larger time difference of the time period l to the time of the situation E, the weight coefficient of situation E to the road section j at the time period l becomes lower. On the other hand, when the space and time of the situation E is closer to the road section j and the time period l, the impact of the situation E to the speed of the road section j at the time period l is larger.

It is noted that though only one situation information analyzing unit 500 is illustrated in the present embodiment, in some embodiments, the traffic forecasting system 100 may include multiple independent situation information analyzing units 500 for the different kinds of situations such as weather, activities, and traffic events, and calculate the weight coefficient Factor_{j,E} according to the above equation. In addition, the above equation is just a possible example for the present disclosure and the weight value of ω_{d} and ωₜ may also be configured according to actual needs, and the situation information analyzing unit 500 may also calculate a proper weight coefficient Factor_{j,E} by various equations.

Similarly, in the present embodiments, the road section mapping module 130 not only map the normalized speed information to the corresponding road section in the map data MAPdata, but may also map the weight coefficient Factor_{j,E} calculated according to the situation information to the corresponding road section in the map data MAPdata, For example, the weight coefficient Factor_{j,E} to situation such as activities and traffic events may be mapped to the corresponding road section where the situation happens and the adjacent road sections, and the weight coefficient Factor_{j,E} to situation such as weather may be mapped to the corresponding road section where the weather station located. Alternatively stated, situation information analyzing unit 500 may calculate proper weight coefficient Factor_{j,E} in response to the impact of different situations to the speed by the weight coefficient computing circuit 520. The same situation (e.g., traffic accident) may have different impact to the speed of different time periods and road sections.

As illustratively shown in FIG. 5, the weight coefficient Factor_{j,E} may be processed and integrated by the situation model forecasting circuit 540 as the situation model and then stored in the situation database 560.

In some embodiments, the effective time of the situation model may be determined according to the start point EffectiveTime_{start,kind} and the end point EffectiveTime_{end,kind}, which may be expressed by the following equations:

$${EffectiveTime}_{start , kind} = {max}_{k} \{ \vert {Speed}_{l - k , non - kind} - {Speed}_{l - k , kind} \vert > {T}_{start} \}$$

$${EffectiveTime}_{end , kind} = {max}_{k} \{ \vert {Speed}_{l + k , non - kind} - {Speed}_{l + k , kind} \vert > {T}_{end} \}$$

In which Tₛₜₐᵣₜ and T_{end} respectively indicate a starting threshold value and an ending threshold value. l indicates the current time to analyze, Speed_{l-k,non-kind}, Speed_{l-k,kind}, Speed_{l+k,non-kind}, and Speed_{l+k,kind} respectively indicate the speed without situation at time (l−k), the speed with situation at time (l−k), the speed without situation at time (l+k), and the speed with situation at time (l+k). Alternatively state, the start point EffectiveTime_{start,kind} and the end point EffectiveTime_{end,kind} are calculated by the time k such that the impact of the situation to the speed is larger than the predetermined threshold Tₛₜₐᵣₜ before time l, and the time k such that the impact of the situation to the speed is larger than the predetermined threshold T_{end} after time l.

Accordingly, when the traffic forecasting system 100 performs forecasting, if the forecasting module 170 determines the corresponding time period of the corresponding road section is in the effective time (i.e., between the start point EffectiveTime_{start,kind} and the end point EffectiveTime_{end,kind}) of the situation model, the forecasting module 170 calculates the estimated vehicle speed for the road section according to the weight coefficient Factor_{j,E} of the situation model.

For example, assuming the original speed of the road section R3 in the time period l is 50 km/hr, and the situation information analyzing unit 500 determines the weight coefficient Factor_{j,E} of the afternoon thunderstorms to the road section RS3 in the time period l is −10 km/hr, then when the forecasting module 170 determines the road section RS3 is in the effective time, the forecasting module 170 adjusts the speed of the road section R3 in the time period l according to the weight coefficient Factor_{j,E} and obtains the estimated vehicle speed value 40 km/hr. It is noted that, in response to different situation, the traffic forecasting system 100 may apply different adjusting ways according to the weight coefficient Factor_{j,E}, such as shifting the estimated vehicle speed, scaling the estimated vehicle speed, or building a new speed to replace the original one. Therefore, the above embodiments are merely examples and not meant to limit the present disclosure.

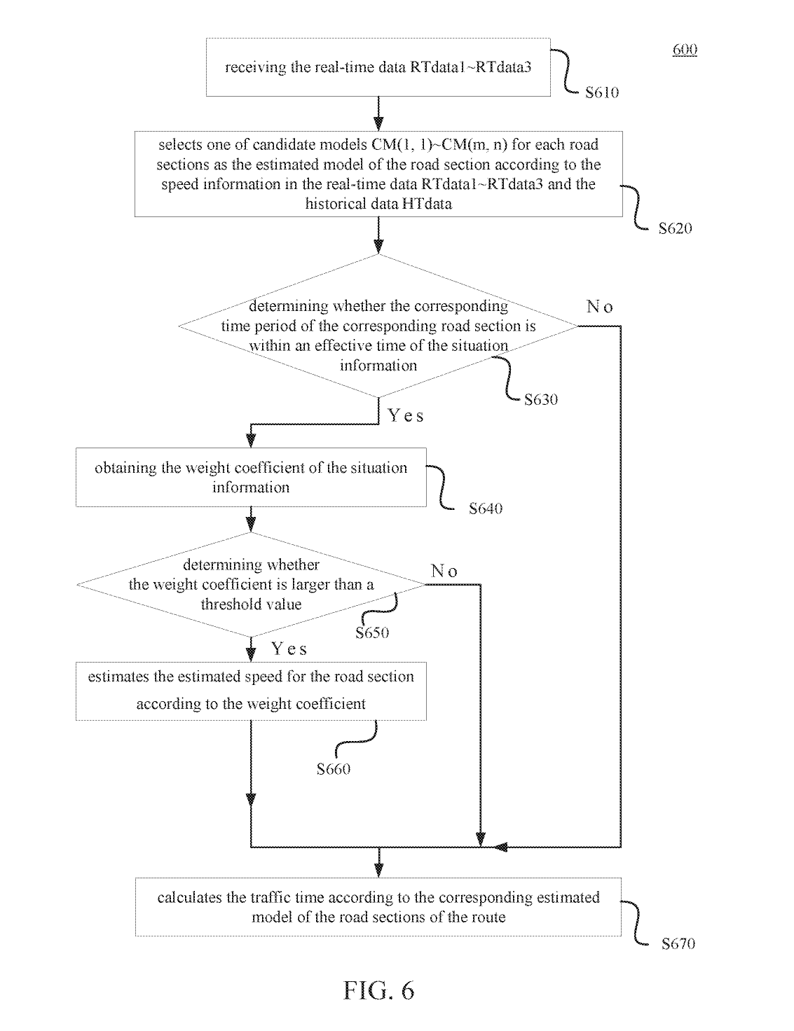

Reference is made to FIG. 6. FIG. 6 is a flowchart illustrating a traffic forecasting method 600 according to some embodiments of the present disclosure. For better understanding of the present disclosure, the traffic forecasting method 600 is discussed in relation to the traffic forecasting system 100 shown in FIG. 1, but is not limited thereto. In some embodiments, the traffic forecasting method 600 is performed by a processor. First, in the step S610, the data-receiving module 110 receives the real-time data RTdata1˜RTdata3. Next, in the step S620, the model selecting module 160 selects one of a plurality of candidate models CM(1, 1)˜CM(m, n) corresponding to the route for each road sections of the route as the estimated model of the road section according to the speed information in the real-time data RTdata1˜RTdata3 and the historical data HTdata stored in the database 180.

Next, in the step S630, the forecasting module 170 determines whether the corresponding time period of the corresponding road section is within an effective time of the situation information. If the result is yes, step S640 is executed, and the situation information analyzing unit 124 calculates the impact caused by the situation at corresponding road section at corresponding time period to obtain the weight coefficient of the situation information. If the result is no, then step S670 is executed and the forecasting module 170 calculates the travel time according to the corresponding estimated model of the road sections of the route. After executing step S640, step S650 is executed and the situation information analyzing unit 124 determines whether the weight coefficient is larger than a threshold value. When the weight coefficient is larger than a threshold value, step S660 is executed, and the forecasting module 170 calculates the estimated vehicle speed for the road section according to the weight coefficient Factor_{j,E} with the situation model generated by the situation model forecasting circuit 540. When the weight coefficient is not larger than the threshold value, or the corresponding time period of the corresponding road section is not within the effective time of the situation information, step S670 is executed and the forecasting module 170 calculates the travel time according to the corresponding estimated model of the road sections of the route. The specific details of the operations of the various modules in the traffic forecasting system 100 to achieve the traffic forecasting method 600 are clearly explained in the above embodiments and thus are omitted herein for the sake of the brevity.

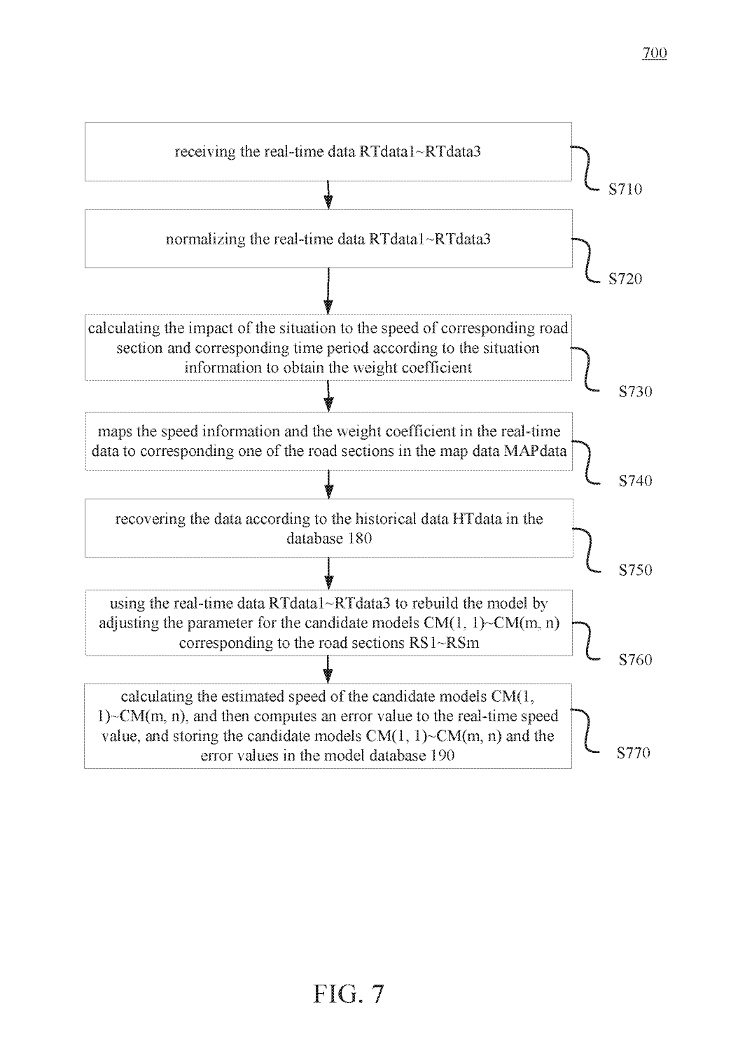

Reference is made to FIG. 7. FIG. 7 is a flowchart illustrating a traffic model establishing method 700 according to some embodiments of the present disclosure. For better understanding of the present disclosure, the traffic model establishing method 700 is discussed in relation to the traffic forecasting system 100 shown in FIG. 1, but is not limited thereto. In some embodiments, the traffic model establishing method 700 is performed by a processor. First, in the step S710, the data-receiving module 110 receives the real-time data RTdata1˜RTdata3. Next, in the step S720, the data normalization unit 122 normalizes the real-time data. Next, in the step S730, the situation information analyzing unit receives the normalized situation information and calculates the impact of the situation to the speed of corresponding road section and corresponding time period according to the situation information to obtain the weight coefficient. Next, in the step S740, the road section mapping module 130 maps the speed information and the weight coefficient in the real-time data to corresponding one of the road sections in the map data MAPdata.

Next, in the step S750, the data-recovery module 140 calculates the speed of the time period missing the speed record in the road section according to the historical data HTdata in the database 180 so as to recover the historical data HTdata.

Next, in the step S760, the model-training module 150 uses the real-time data RTdata1˜RTdata3 to rebuild the model by adjusting the parameter for the candidate models CM(1, 1)˜CM(m, n) corresponding to the road sections RS1˜RSm.

In the end, in the step S770, forecasting module 160 calculates the estimated vehicle speed of the candidate models CM(1, 1)˜CM(m, n), and then computes an error value to the real-time speed value, and stores the candidate models CM(1, 1)˜CM(m, n) and the error values in the model database 190.

The specific details of the operations of the various modules in the traffic forecasting system 100 to achieve the traffic model establishing method 700 are clearly explained in the above embodiments and thus are omitted herein for the sake of the brevity.

Accordingly, the traffic forecasting system 100 is able to perform the traffic forecasting method 600 and the traffic model establishing method 700 to improve the accuracy and the reliability of the traffic forecasting. Since in each road section the selected estimated model is the estimated model with high accuracy, the total accuracy is improved efficiently. In addition, the traffic forecasting system 100 may adjust the estimated vehicle speed according to different situations and events so as to further improve the accuracy.

It is noted that in some embodiments, the traffic forecasting system 100 may include a memory and a processor module. The memory may store at least one executable program for the processor to execute the operations performed in the traffic forecasting method 600 and the traffic model establishing method 700 stated above. In addition, the traffic forecasting method 600 and the traffic model establishing method 700 may also be implemented with a computer, or part of the functions is implemented in a computer program that is stored in a non-transitory computer-readable storage medium to allow a computer to perform the traffic forecasting method 600 and the traffic model establishing method 700 after reading the storage medium, but the present disclosure is not limited thereto.

In addition, the function modules as mentioned previously, may be specifically implemented in software or hardware and/or firmware. For example, if the operating speed and precision are both the first considerations, these modules may be mainly implemented in hardware and/or firmware. If design flexibility is the first consideration, these modules are mainly implemented in software. Or, these modules operate with the collaboration of software, hardware, and firmware. It is noted that none of the above examples is more preferable than any of the other examples, nor are they intended to limit the present disclosure. One skilled in the art may specifically implement these modules with flexibility according to the requirements then. For example, the modules may be integrated in a central processing unit (CPU).

Although the disclosure has been described in considerable detail with reference to certain embodiments thereof, it will be understood that the embodiments are not intended to limit the disclosure. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A traffic forecasting system configured to forecast a travel time of a route, comprising:
a model-training module configured to build a plurality of candidate models, wherein each of the candidate models corresponds to one of a plurality of road sections and one of a plurality of mathematical models;
a model-selecting module configured to select a corresponding estimated model from the candidate models matching the road sections of the route for each road section; and
a forecasting module configured to calculate an estimated vehicle speed for each road section according to the estimated model of each road section of the route, so as to calculate the travel time of the route;
wherein the model-selecting module selects one of the candidate models corresponding to the road section with the smallest error as the estimated model of the road section.

2. The traffic forecasting system of claim 1, further comprising:
a traffic historical database configured to store at least one historical data, wherein the historical data comprises speed records corresponding to one of the road section in a corresponding time period;
a model database configured to store the candidate models corresponding to different time periods, different situation, and different mathematical models; and
a data-receiving module configured to receive at least one real-time data, wherein the real-time data comprises a real-time speed information corresponding to one of the road section;
wherein the model-selecting module is configured to calculate a estimation error value for each candidate model according to the historical data and the real-time data so as to select the candidate model with the smallest error as the estimated model of the road section.

3. The traffic forecasting system of claim 2, further comprising:
a data-processing module electrically coupled to the data-receiving module and configured to perform data processing to the real-time data; and
a road section mapping module electrically coupled to the data processing module and configured to map the processed real-time data to corresponding road section in a map data so as to store the real-time data as the historical data in the traffic historical database.

4. The traffic forecasting system of claim 3, wherein the real-time data further comprises at least one situation information, and the data-processing module comprises:
a data normalization unit configured to normalize the situation information and the real-time speed information in the real-time data.

5. The traffic forecasting system of claim 3, wherein the real-time data further comprises at least one situation information, and the data-processing module comprises:
a situation information analyzing unit configured to receive the situation information and calculate a weight coefficient indicating the impact of the situation information on the traffic speed of corresponding road section at corresponding time period.

6. The traffic forecasting system of claim 5, wherein the situation information analyzing unit is configured to build a situation model according to the weight coefficient, and when the forecasting module determines the corresponding time period of the corresponding road section is in an effective time of the situation model, the forecasting module calculates the estimated vehicle speed for the road section according to the weight coefficient of the situation model.

7. The traffic forecasting system of claim 2, further comprising:
a data-recovery module electrically coupled to the traffic historical database and configured to calculate the speed of the time period missing the speed record in the road section according to the historical data so as to recover the historical data.

8. The traffic forecasting system of claim 7, wherein the data-recovery module is configured to perform a space-series data recovery and calculate the speed information of the corresponding road section according to the speed information of multiple adjacent road sections.

9. The traffic forecasting system of claim 7, wherein the data-recovery module is configured to perform a time-series data recovery and calculate the speed information of the corresponding road section according to the speed information of multiple adjacent time periods.

10. A traffic forecasting method performed by a processor, wherein the traffic forecasting method comprises following steps:
(a) receiving, by the processor, at least one real-time data;
(b) selecting, by the processor, one of a plurality of candidate models corresponding to a route for each road sections of the route as the estimated model of the road section;
(c) calculating, by the processor, a travel time according to the corresponding estimated model of the road sections of the route;
wherein the estimated model of each road section are selected according to the real-time data and a historical data in a database such that the candidate model corresponding to the road section with the smallest error is selected as the estimated model of the road section.

11. The traffic forecasting method of claim 10, wherein the at least one real-time data further comprises a situation information, and the traffic forecasting method further comprises following steps:
(d) determining, by the processor, whether corresponding time period of the corresponding road section is within an effective time of the situation information;
(e) calculating, by the processor, a weight coefficient of the situation information at corresponding road section at corresponding time period when the corresponding time period of the corresponding road section is within the effective time; and
(f) selecting, by the processor, corresponding estimated model to calculate the estimated vehicle speed for the road section according to the weight coefficient.

12. The traffic forecasting method of claim 11, wherein the step of selecting corresponding estimated model according to the weight coefficient further comprises:
when the weight coefficient is larger than a threshold value, calculating the estimated vehicle speed for the road section according to the weight coefficient with a situation model corresponding to the situation information.

13. The traffic forecasting method of claim 11, wherein the effective time of the situation information is between a start point and an end point, wherein the start point and the end point are calculated according to the time period in which the impact of the situation information to the estimated vehicle speed is larger than a threshold value.

14. The traffic forecasting method of claim 11, wherein the situation information comprises at least one of weather information, activities information, and traffic event information.

15. A traffic model establishing method performed by a processor, wherein the traffic model establishing method comprises following steps:
(a) receiving, by the processor, at least one real-time data wherein the at least one real-time data comprises a speed information;
(b) mapping, by the processor, the speed information in the at least one real-time data to corresponding one of a plurality of road sections in a map data; and
(c) calculating, by the processor, a plurality of candidate models corresponding to a plurality of different mathematical models for each of the road sections, such that a model-selecting module selects one of the candidate models of the road sections as an estimated model of the corresponding road section according to the at least one real-time data and a historical data in a traffic historical database.

16. The traffic model establishing method of claim 15, wherein the at least one real-time data further comprises a situation information, and the traffic model establishing method further comprises following steps:
(d) normalizing, by the processor, the speed information and the situation information in the real-time data;
(e) calculating, by the processor, a weight coefficient of the situation information at corresponding road section and corresponding time period according to the situation information; and
(f) mapping, by the processor, the weight coefficient to the corresponding one of the road sections in the map data.

17. The traffic model establishing method of claim 15, the traffic model establishing method further comprises following steps:
(g) performing a space-series recovery, by the processor, to the historical data in the traffic historical database and calculate the speed information of the corresponding road section according to the speed information of multiple adjacent road sections.

18. The traffic model establishing method of claim 15, the traffic model establishing method further comprises following steps:
(h) performing a time-series recovery, by the processor, to the historical data in the traffic historical database and calculate the speed information of the corresponding road section according to the speed information of multiple adjacent time periods.
